(19) United States
(12) Patent Application Publication
(10) Pub. No.: US 2026/0147253 A1
(43) Pub. Date: May 28, 2026

(54) OPTICAL APPARATUS AND IMAGE PICKUP APPARATUS

(71) Applicant: CANON KABUSHIKI KAISHA, Tokyo (JP)

(72) Inventors: TOMONORI ISHIKAWA, Tochigi (JP); KAZUHIRO NOGUCHI, Tochigi (JP); KOHEI KARASAWA, Tochigi (JP)

(21) Appl. No.: 19/350,133

(22) Filed: Oct. 6, 2025

(30) Foreign Application Priority Data
Nov. 22, 2024 (JP) 2024-203571

(51) Int. Cl. G03B 13/34; G03B 17/14

(52) U.S. Cl. CPC G03B 13/34; G03B 17/14

(57) ABSTRACT

An optical apparatus includes a base member, a holding member that holds an optical element and is movable relative to the base member, a first guide member fixed to the base member, a second guide member fixed to the holding member, a rolling member disposed between the first guide member and the second guide member, and a biasing unit provided on the holding member. The rolling member rolls relative to the first guide member and the second guide member to guide a movement of the holding member. The first guide member and the biasing unit generate a biasing force that biases the holding member toward the first guide member.

### BACKGROUND

### Field of the Technology

The aspect of the disclosure relates to one or more embodiments of an optical apparatus and an image pickup apparatus.

### Description of the Related Art

An optical apparatus configured to guide an optical element, such as a lens, in an optical axis direction by sliding along two guide bars a holding member that holds the optical element has a gap (play) that allows sliding between the holding member and the guide bars, and biases the play to one side by a biasing force of a spring or the like. The biasing force is set to a strength that suppresses the play due to the weight of the optical element even when the orientation of the optical apparatus changes from horizontal to upward or downward. In order to reduce the drive load on the optical element due to this biasing force, Japanese Patent Application Laid-Open No. 2010-048984 discloses a structure in which a ball rolls along a V-groove, and PCT International Publication No. WO 2018/105267 discloses a structure in which a ball rolls along two guide bars.

### SUMMARY

One or more embodiments of an optical apparatus according to one or more aspects of the disclosure may include a base member, a holding member that holds an optical element and is movable relative to the base member, a first guide member fixed to the base member, a second guide member fixed to the holding member, a rolling member disposed between the first guide member and the second guide member, and a biasing unit provided on the holding member. The rolling member rolls relative to the first guide member and the second guide member to guide a movement of the holding member. The first guide member and the biasing unit generate a biasing force that biases the holding member toward the first guide member. One or more image pickup apparatuses may include one or more optical apparatuses in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 illustrates the configuration of an image pickup apparatus including a lens apparatus according to a first embodiment.

FIG. 2 is a perspective view of a lens holder in the lens apparatus according to the first embodiment.

FIG. 3 is an exploded perspective view of the lens apparatus according to the first embodiment.

FIGS. 4A and 4B are side and sectional views of the lens holder according to the first embodiment.

FIGS. 5A and 5B illustrate a guide portion of the lens holder according to the first embodiment.

FIG. 6 is a perspective view of the lens holder according to the first embodiment.

FIG. 7 is a perspective view of the lens holder (with a guide bar) according to the first embodiment.

FIG. 8 illustrates a relationship between a ball and a retainer in the first embodiment.

FIG. 9 is a perspective view of a lens holder according to a second embodiment.

FIG. 10 is an exploded perspective view of the lens apparatus of the second embodiment.

FIGS. 11A and 11B are side and sectional views of the lens holder according to the second embodiment.

FIG. 12 is a perspective view of the lens holder according to the second embodiment.

FIG. 13 is a perspective view of a lens holder according to a third embodiment.

FIG. 14 is a perspective view of the lens holder according to the third embodiment.

FIGS. 15A and 15B are perspective and exploded perspective views of a biasing unit in the lens holder according to the third embodiment.

FIG. 16 is a perspective view of the guide portion in the lens holder according to the third embodiment.

FIGS. 17A and 17B are side and sectional views of the lens holder of the third embodiment.

### DESCRIPTION OF THE EMBODIMENTS

Referring now to the accompanying drawings, a description will be given of embodiments according to the disclosure.

### FIRST EMBODIMENT

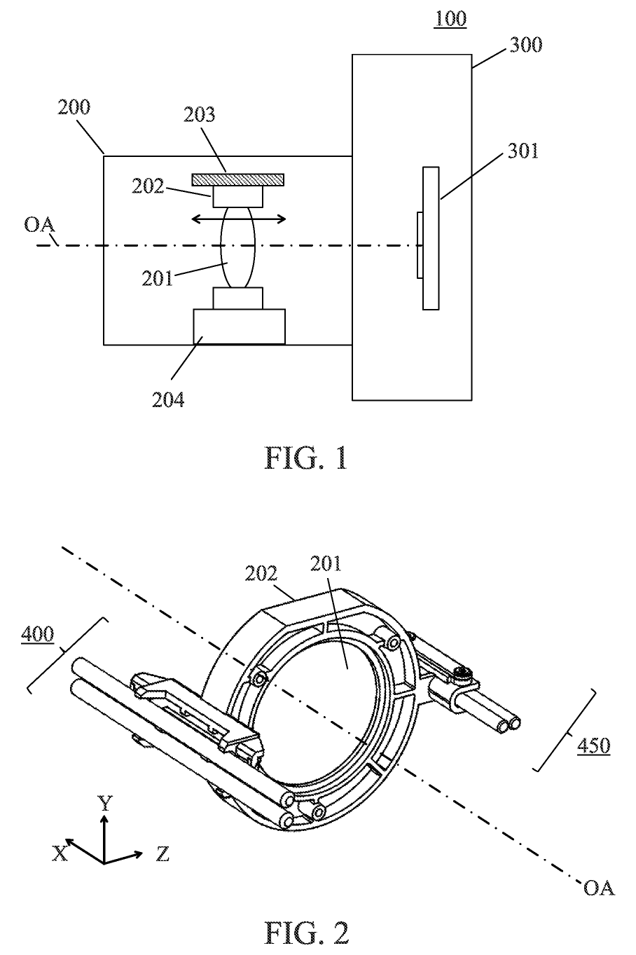

FIG. 1 illustrates a schematic configuration of an image pickup apparatus 100 including a lens apparatus 200 as an optical apparatus according to an embodiment. The lens apparatus 200 includes an imaging optical system (not illustrated) and a drive mechanism that supports at least a part of the optical elements of the imaging optical system and drives it in an optical axis direction along which the optical axis OA extends. The camera body 300 includes an image sensor 301.

The lens apparatus 200 and the camera body 300 are mechanically integrated by a mount (not illustrated). A light beam from an object forms an image on the image sensor 301 via the imaging optical system in the lens apparatus 200. The lens apparatus 200 and the camera body 300 are electrically connected via electrical contacts (not illustrated) and can communicate with each other.

A lens 201 is an optical element that constitutes part of the imaging optical system, and is held by a lens holder 202, which serves as a holding member. The lens holder 202 is movable in the optical axis direction along a guide 204. The drive mechanism 203 includes a stepping motor or a voice coil motor consisting of a magnetic circuit and a field coil, and drives the lens holder 202 (i.e., the lens 201) in the optical axis direction.

In this embodiment, the lens 201 is a focus lens that moves in the optical axis direction to focus on an object from the closest distance to infinity. However, the lens 201 may also be a zoom lens that moves for zooming, or an aperture unit that changes a light amount.

The image sensor 301 is a photoelectric conversion element such as a CMOS sensor that converts incident light into an electrical signal, and captures an object image formed by the imaging optical system.

This embodiment will discuss the image pickup apparatus 100 as a lens interchangeable type image pickup apparatus in which the lens apparatus 200 is attachable and detachable, but the image pickup apparatus may also be a lens integrated type in which the lens apparatus is integrated.

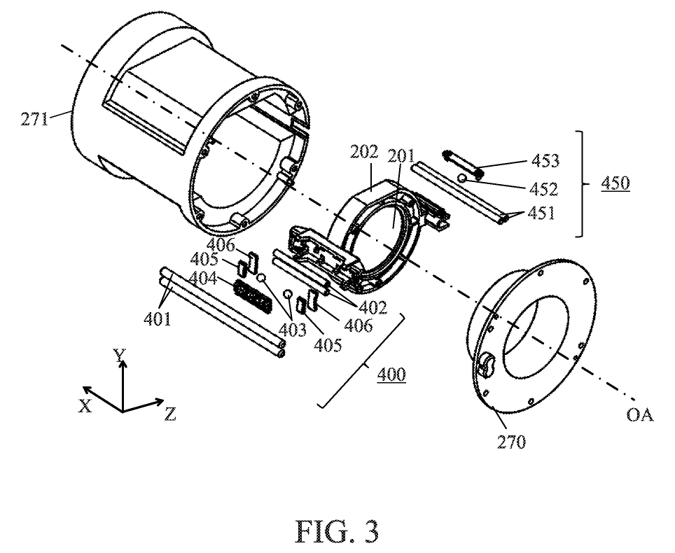

FIG. 2 illustrates the lens holder 202, and FIG. 3 is an exploded view of the lens apparatus 200. Here, the optical axis direction is an X direction, a horizontal direction when a plane perpendicular to the optical axis direction is viewed from the optical axis direction is a Z direction, and the vertical direction is a Y direction.

The lens holder 202 that holds the lens 201 is guided in the optical axis direction by two fixed guide bars 401 that serve as main guide members (first guide members or guide portions included in the first guide member) extending in the optical axis direction. Each fixed guide bar 401 is held by a front fixed frame 270 at its object-side end and a rear fixed frame 271 at its image-side end, and thereby is fixed to the lens barrel housing, which serves as a base member formed by combining the front fixed frame 270 and the rear fixed frame 271. In this embodiment, each fixed guide bar 401 is made of a magnetic material such as SUS430. SUS430 is highly corrosion-resistant, does not require surface treatment, is easy to process, and is suitable for guide bars from the perspective of high mechanical precision such as roundness, straightness, and surface roughness.

The lens holder 202 has two movable guide bars 402 that serve as second guide members and two magnets 405 that serve as a biasing force generator. The yokes 406 disposed on the back of each magnet 405 are magnetically attracted to and connected to the magnets 405, and are further firmly integrated with the lens holder 202 by adhesive. In this embodiment, the two magnets 405 and the two yokes 406 are arranged near both ends of the movable guide bar 402 of the lens holder 202. Furthermore, the two magnets 405 and the yokes 406 are arranged so as to sandwich the center between two rolling members, which will be described later, in the optical axis direction (a moving direction of the lens holder 202).

Arranged between the two fixed guide bars 401 and the two movable guide bars 402 are two balls 403, one on the object side and one on the image side, which serve as rolling members (or a plurality of rolling portions of the rolling member), and a retainer (rolling holding member) 404 that rollably holds them. Each ball 403 contacts two fixed guide bars 401 and two movable guide bars 402, respectively. The two fixed guide bars 401, two movable guide bars 402, two balls 403, and retainer 404 form the main guide portion 400. Since each of the guide bars 401, 402, and balls 403 has high mechanical precision, the main guide portion 400, which combines them, also has high mechanical precision, thereby achieving high positional precision for the lens 201. Rollers may be used as rolling members instead of the balls 403.

Two sub-guide bars 451 are disposed opposite the main guide portion 400 with respect to the optical axis OA of the lens holder 202. Each sub-guide bar 451 is a sub-guide member that extends in the optical axis direction, and is fixed to the lens barrel housing by having its object-side end held by the front fixed frame 270 and its image-side end held by the rear fixed frame 271. The lens holder 202 has a U-shaped groove into which two sub-guide bars 451 are inserted. A ball 452 is sandwiched in the Y direction between the two sub-guide bars 451 and a flat plate 453. The ball 452 can roll while being in contact with the two sub-guide bars 451 and the flat plate 453. These two sub-guide bars 451, ball 452, and flat plate 453 form a sub-guide portion (third guide member) 450.

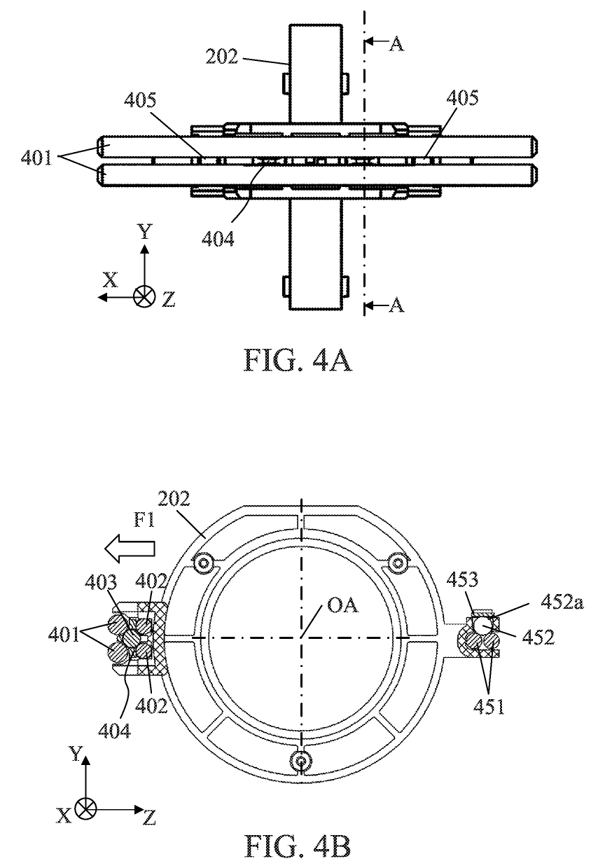

FIG. 4A illustrates the lens holder 202 when viewed from the main guide portion side, and FIG. 4B illustrates the A-A cross section in FIG. 4A.

As described above, the fixed guide bar 401 is made of a magnetic material, and a magnetic attractive force acts between it and the magnet 405 fixed to the lens holder 202. As illustrated in FIG. 4B , the magnetic attractive force F1 acts in the direction from the movable guide bar 402 to the fixed guide bar 401, so the two balls 403 are sandwiched and held between the fixed guide bar 401 and the movable guide bar 402. That is, the two fixed guide bars 401 and the magnet 405 generate a biasing force as the magnetic attractive force F1, and this biasing force biases the lens holder 202 against the two fixed guide bars 401 via the two balls 403. Due to this structure, when the lens holder 202 moves in the optical axis direction along the two fixed guide bars 401, the two balls 403 roll between the two fixed guide bars 401 and the two movable guide bars 402. Thereby, the driving resistance of the lens holder 202 (the driving load of the driving mechanism 203) is extremely reduced.

As illustrated in FIG. 4B, an opening 452a is formed in one wall of the U-groove portion of lens holder 202 through which the two sub-guide bars 451 are inserted. The ball 452 contacts the flat plate 453 fixed to one wall of the U-groove portion with a screw through the opening 452a, and is sandwiched between the flat plate 453 and the two sub-guide bars 451. The sub-guide portion 450 configured in this manner prevents the lens holder 202 from rotating around the two balls 403 (in a plane perpendicular to the optical axis direction).

This embodiment does not explicitly illustrate a biasing unit configured to generate a biasing force that brings the ball 452 and the sub-guide bar 451 into contact, but may provide such a biasing unit.

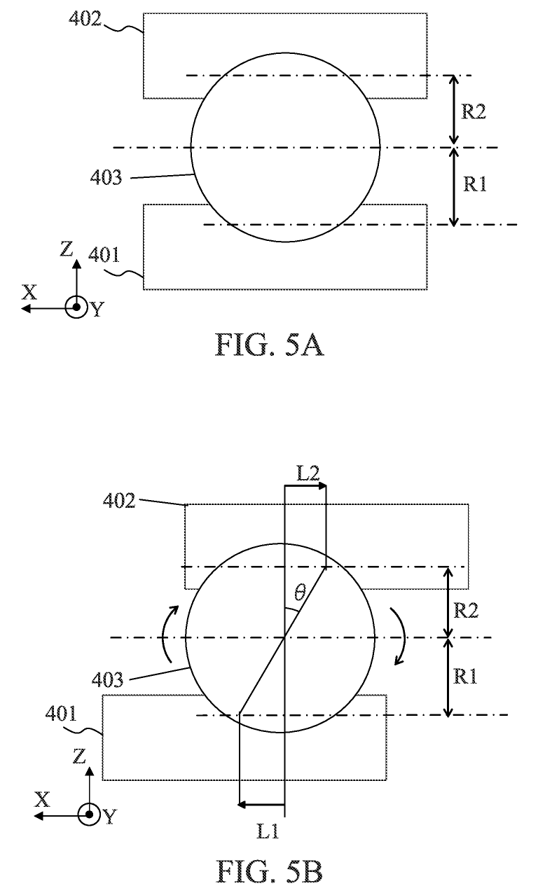

FIG. 5A illustrates a relationship between the fixed guide bar 401, movable guide bar 402, and ball 403 when viewed from the Y direction. FIG. 5A illustrates the state in which the ball 403 is sandwiched in the Z direction between one of the two fixed guide bars 401 and one of the two movable guide bars 402. In FIG. 5A, R1 denotes a distance (height) from the center of ball 403 to the contact point between fixed guide bar 401 and ball 403, and R2 denotes the height from the center of ball 403 to the contact point between movable guide bar 402 and ball 403.

FIG. 5B illustrates a state after ball 403 has rolled in the -X direction by an angle θ from the state illustrated in FIG. 5A. The distance moved by the fixed guide bar 401 in the X direction relative to the center of ball 403 that has rolled by the angle θ is L1, and the distance moved by movable guide bar 402 in the -X direction is L2. The magnitude relationship (ratio) between L1 and L2 corresponds to the magnitude relationship (ratio) between a length of an arc corresponding to the angle θ in a circle with R1 as a rotation radius and a length of an arc corresponding to the angle θ in a circle with R2 as a rotation radius. Therefore, the distance moved by movable guide bar 402 relative to fixed guide bar 401 is L1 + L2. Since the ball 403 rolls on the fixed guide bar 401 and movable guide bar 402, the driving resistance is extremely small. The main guide portion 400 is set so that L1 + L2 satisfies a necessary moving distance for the lens holder 202.

In this embodiment, the relationship between the guide bars 401 and 402 and the ball 403 is set so that R1 > R2. Thereby, the length of the movable guide bar 402 for the rolling of the ball 403 can be shorter than that when R1 = R2.

FIG. 6 illustrates the structure of the lens holder 202 for the main guide portion 400. The lens holder 202 has a frame portion 405a that fixes the magnets 405 and yokes 406. As described above, the magnet 405 and yoke 406 are magnetically coupled to each other and are fixed by adhesive near both ends of the two movable guide bars 402 of the lens holder 202.

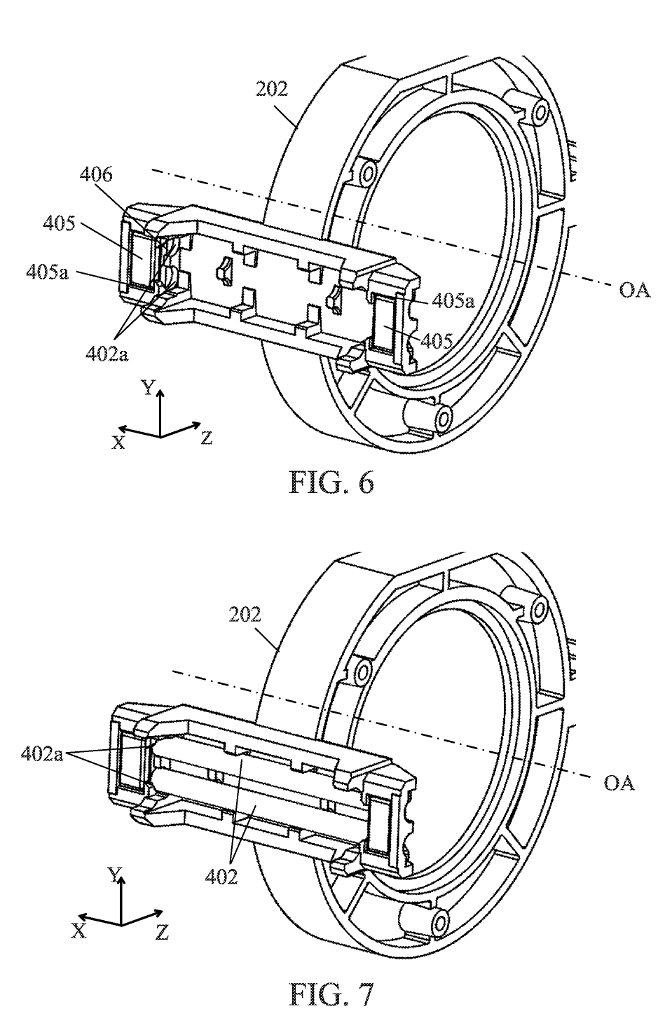

The lens holder 202 has a total of four holes 402a, two of which are located on the object side and the other two of which are located on the image side, through which the two movable guide bars 402 are inserted. As illustrated in FIG. 7, the two movable guide bars 402 are held by the lens holder 202 by being inserted into the holes 402a.

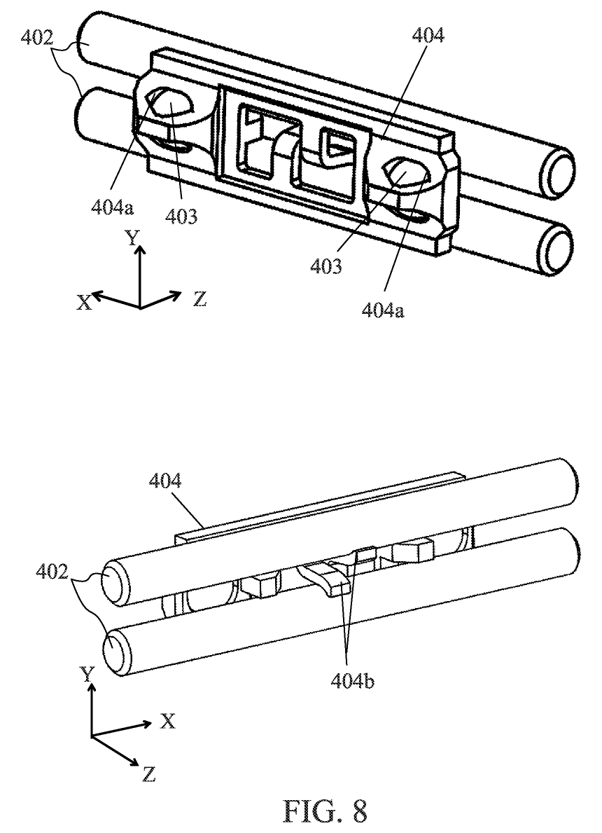

FIG. 8 illustrates an enlarged view of the two movable guide bars 402, balls 403, and retainer 404. The upper figure is viewed from the +Z direction, and the lower figure is viewed from the -Z direction.

The retainer 404 has two holders 404a, one on the object side and one on the image side, and a ball 403 is disposed within each holder 404a. Openings are formed in two places in the Y direction in each holder 404a, and the balls 403 exposed from the openings roll while being in contact with the two fixed guide bars 401. The retainer 404 prevents the two balls 403 from approaching each other, and maintains a predetermined distance between them in the optical axis direction. Thereby, the balls 403 can be prevented from riding up onto either of the two movable guide bars 402 when a moment about the Z or Y axis acts on the lens holder 202 due to the lens apparatus 200 falling to the ground or the like.

As illustrated in the lower diagram in FIG. 8, the retainer 404 has two anti-dislodging portions 404b. By inserting these anti-dislodging portions 404b between the two movable guide bars 402 and engaging them with the movable guide bars 402, the two balls 403 are prevented from falling out from between the two movable guide bars 402 and the two fixed guide bars 401.

The two balls 403 roll within the range of both ends where the retainer 404 and lens holder 202 contact each other in the optical axis direction. The rolling range of the two balls 403 is set so that, for example, even when the retainer 404 contacts the +X-direction-side end of the lens holder 202, the two balls 403 are not positioned within the +X-direction range of the center of the movable guide bar 402. Thereby, the center of gravity (center) of the biasing force acting from the two magnets 405 is always located between the two balls 403, and prevents one of the balls 403 from floating away from the respective guide bars.

### SECOND EMBODIMENT

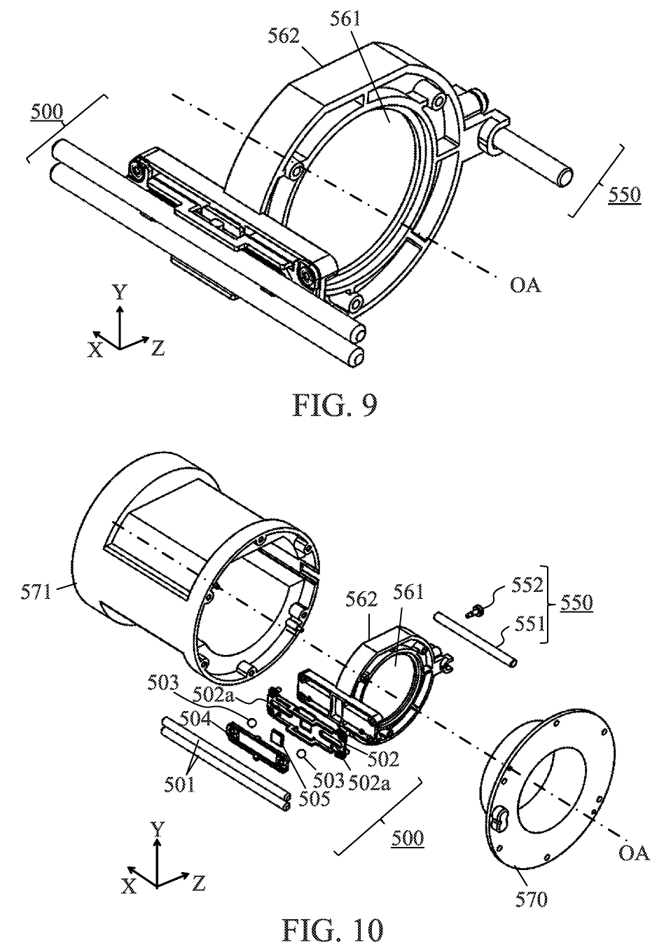

FIG. 9 illustrates a lens holder 562 of a second embodiment, and FIG. 10 illustrates an exploded view of a lens apparatus including the lens holder 562.

The lens holder 562 is guided in the optical axis direction by two fixed guide bars 501 that serve as main guide members (first guide members). The two fixed guide bars 501 have object-side ends held by a front fixed frame 570 and image-side ends held by a rear fixed frame 571, and are fixed to a lens barrel housing formed by joining the front fixed frame 570 and the rear fixed frame 571. Each fixed guide bar 501 is made of a magnetic material, as in the first embodiment.

A metal plate (second guide member: referred to as a V-groove metal plate hereinafter) 502, which has two V-groove portions 502a formed on the object side and the image side, is fixed with screws to the lens holder 562. The V-groove metal plate 502 is made of a magnetic material, and a magnet 505 serving as a biasing force generator is attracted and fixed to the center of the V-groove metal plate 502 in the optical axis direction (between two rolling members, which will be described later).

Two balls 503, one on the object side and one on the image side, serving as rolling members, and a retainer (rolling holding member) 504 that rollably holds them are arranged between the two fixed guide bars 501 and the V-groove metal plate 502. Each ball 503 contacts the two fixed guide bars 501 and the V-groove portion 502a of the V-groove metal plate 502, respectively. The two fixed guide bars 501, the V-groove metal plate 502, the two balls 503, and the retainer 504 form the main guide unit 500.

A sub-guide bar 551 is disposed opposite to the main guide unit 500 with respect to the optical axis OA in the lens holder 562. The sub-guide bar 551 is a sub-guide member that extends in the optical axis direction. Since its object-side end is held by the front fixed frame 570 and its image-side end is held by the rear fixed frame 571, it is fixed to the lens barrel housing. The lens holder 562 has a U-shaped groove into which the sub-guide bar 551 is inserted. A bearing 552 is provided on one wall of the U-groove. The bearing 552 contacts the sub-guide bar 551. The sub-guide bar 551 and bearing 552 form a sub-guide unit (third guide member) 550. The sub-guide unit 550 configured in this manner can prevent the lens holder 562 from rotating around the two balls 503.

This embodiment does not explicitly illustrate a biasing unit for generating a biasing force that brings the bearing 552 and sub-guide bar 551 into contact, but may provide such a biasing unit.

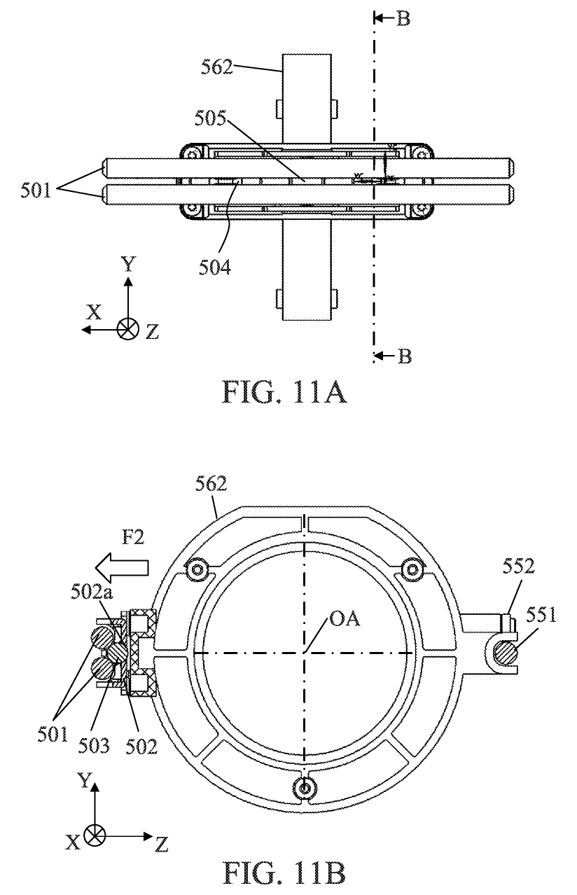

FIG. 11A illustrates the lens holder 562 when viewed from the main guide portion side, and FIG. 11B illustrates the B-B cross section in FIG. 11A.

As described above, the fixed guide bar 501 is made of a magnetic material, and a magnetic attractive force acts between it and the magnet 505 fixed to the V-groove metal plate 502. As illustrated in FIG. 11B , the magnetic attractive force F2 acts in the direction from the V-groove metal plate 502 to the fixed guide bar 501, so the two balls 503 are sandwiched and held between the fixed guide bar 501 and the V-groove portion 502a of the V-groove metal plate 502. That is, the two fixed guide bars 501 and the magnet 505 generate a biasing force as the magnetic attractive force F2, and this biasing force biases the lens holder 562 against the two fixed guide bars 501 via the two balls 503. Due to this structure, when the lens holder 562 moves in the optical axis direction along the two fixed guide bars 501, the two balls 503 roll between the two fixed guide bars 501 and the V-groove metal plate 502. Thereby, the driving resistance of the lens holder 562 is extremely reduced.

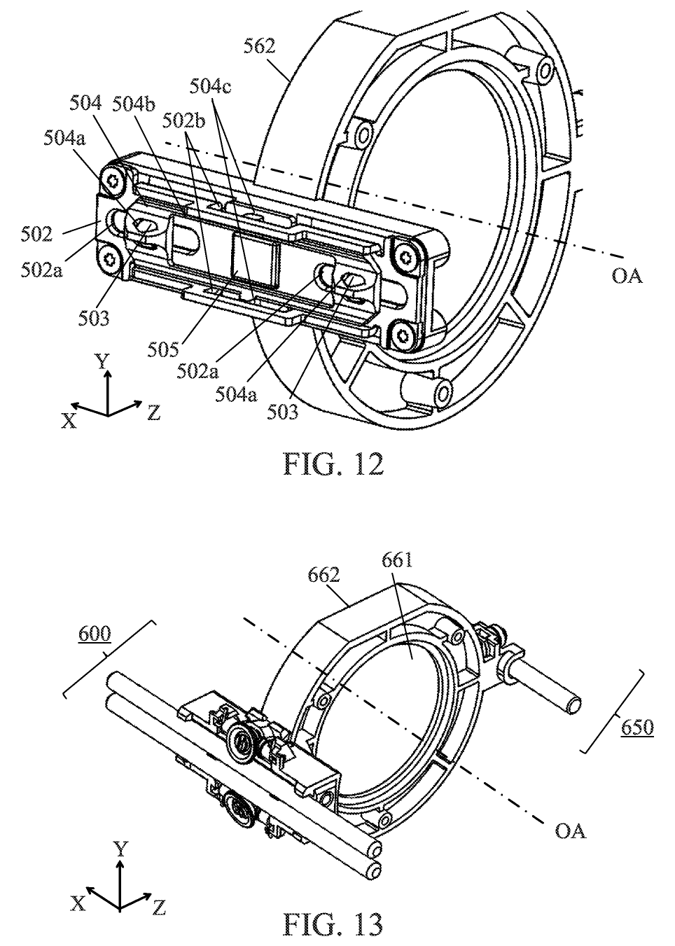

FIG. 12 illustrates an enlarged view of the lens holder 562, the two balls 503, and the retainer 504. The retainer 504 has two holders 504a, one on the object side and one on the image side, and a ball 503 is disposed in each holder 504a. Openings are formed in two locations in the Y direction of each holder 504a, and the balls 503 exposed from the openings roll while being in contact with the two fixed guide bars 501. The retainer 504 prevents the two balls 503 from approaching each other, maintaining a predetermined distance between them in the optical axis direction.

A rectangular opening 504b is formed between the two holders 504a in the retainer 504. Since the retainer 504 has the rectangular opening 504b, it does not interfere with the magnet 505 located in the center of the V-groove metal plate 502, even when the retainer 504 moves in the optical axis direction.

In this embodiment, the magnet 505 is located between the two V-groove portions 502a. Therefore, regardless of the position of the lens holder 562, the center of gravity (line of action) of the biasing force acting from the magnet 505 is always located between the two balls 503, preventing one of the balls 503 from floating away from the fixed guide bar 501 and the V-groove portion 502a.

Furthermore, since the magnet 505 is located between the V-groove portions 502a, the size of the V-groove metal plate 502 in the optical axis direction can be smaller than that in the structure in which the magnets 405 are located on both sides in the optical axis direction, as in the first embodiment.

The retainer 504 has anti-dislodging portions 504c as protrusions on both sides in the Y direction. By inserting these anti-dislodging portions 504c into the inside of the frame portions 502b provided on both sides of the V-groove metal plate 502 in the Y direction, the two balls 503 are prevented from dislodging from between the V-groove portions 502a and the two fixed guide bars 501.

In this embodiment, the second guide member is formed by the V-groove portions 502a of the V-groove metal plate 502. In this case, a rolling range of the balls 503 is limited by the length of the V-groove portions 502a. Thus, the retainer 504 is not necessarily provided. The V-groove metal plate 502 corresponds to a single component that replaces the two movable guide bars 402 in the first embodiment, and functions as a yoke for the magnet 505 and prevents the retainer 504 from slipping out.

### THIRD EMBODIMENT

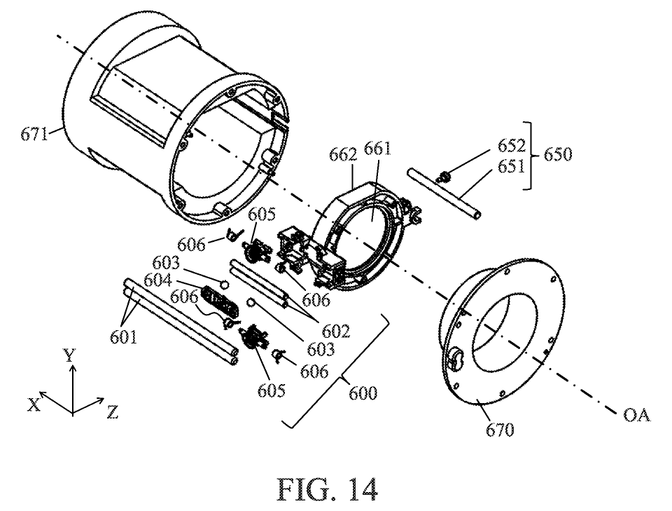

FIG. 13 illustrates a lens holder 662 according to a third embodiment, and FIG. 14 illustrates an exploded view of the lens apparatus including the lens holder 662.

The lens holder 662 is guided in the optical axis direction by two fixed guide bars 601 that serve as main guide members (first guide members). The two fixed guide bars 601 have object-side ends held by a front fixed frame 670 and image-side ends held by a rear fixed frame 671, and are fixed to a lens barrel housing formed by combining the front fixed frame 670 and the rear fixed frame 671. Unlike the first and second embodiments, each fixed guide bar 601 may be made of a metal that is not a magnetic material.

The lens holder 202 has two movable guide bars 602 as second guide members and a biasing unit 605 that constitutes a biasing force generator. Two biasing units (or a plurality of biasing portions of the biasing unit) 605 are provided in the Y direction. Each biasing unit 605 is provided between two rolling members, which will be described later, in the optical axis direction.

Two balls 603, one on the object side and the other on the image side, serving as rolling members, and a retainer (rolling holding member) 604 that rollably holds them are arranged between the two fixed guide bars 601 and the two movable guide bars 602. Each ball 603 contacts the two fixed guide bars 601 and the two movable guide bars 602. The two fixed guide bars 601, the two movable guide bars 602, the two balls 603, and the retainer 604 form a main guide unit 600.

A sub-guide bar 651 is disposed opposite the main guide unit 600 with respect to the optical axis OA in the lens holder 662. The sub-guide bar 651 is a secondary guide member that extends in the optical axis direction, and is fixed to the lens barrel housing by having its object-side end held by the front fixed frame 670 and its image-side end held by the rear fixed frame 671. The lens holder 662 has a U-shaped groove into which sub-guide bar 651 is inserted. A bearing 652 is provided on one wall of the U-groove. The bearing 652 contacts the sub-guide bar 651. The sub-guide bar 651 and bearing 652 form sub-guide portion (third guide member) 650. The sub-guide portion 650 prevents the lens holder 662 from rotating around the two balls 603.

This embodiment does not explicitly illustrate a biasing unit configured to generate a biasing force that brings the bearing 652 and sub-guide bar 651 into contact, but may provide such a biasing unit.

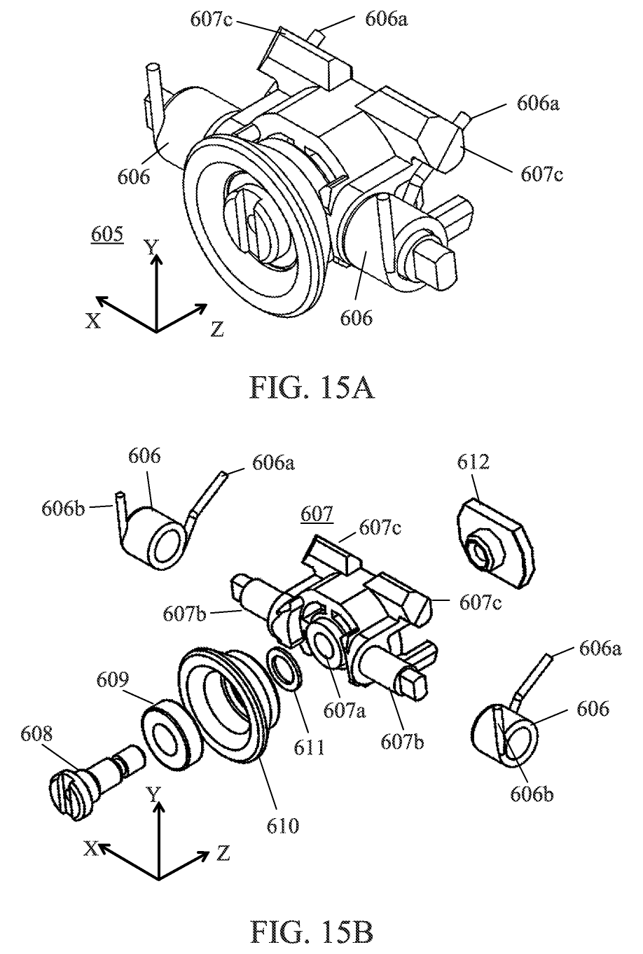

FIG. 15A illustrates the external appearance of the biasing unit 605, and FIG. 15B is an exploded view of the biasing unit 605. The biasing unit 605 includes a support member 607, a shaft screw 608, and a ball bearing 609. The ball bearing 609 has a roller (contact member) 610, a washer 611, a nut 612, and a torsion coil spring 606. Like a typical ball bearing, the ball bearing 609 includes an inner ring, an outer ring, balls, and a cage that holds the balls. The outer ring rotates as the balls roll relative to the inner ring, so drive resistance is extremely low.

The ball bearing 609 is located on the inner circumference of the roller 610. The shaft screw 608 is threaded into the nut 612 in the Z direction through the inner circumferences of the ball bearing 609, roller 610, and washer 611, as well as through a hole 607a in the support member 607. Thereby, the roller 610 is rotatably held by the ball bearing 609 and attached to the support member 607.

Protrusions 607b are provided on both sides of the support member 607 in the X direction. A torsion coil spring 606 is disposed on the outer circumference of each protrusion 607b. Each torsion coil spring 606 has arm portions 606a and 606b. The arm portion 606a contacts a contact portion 607c of the support member 607.

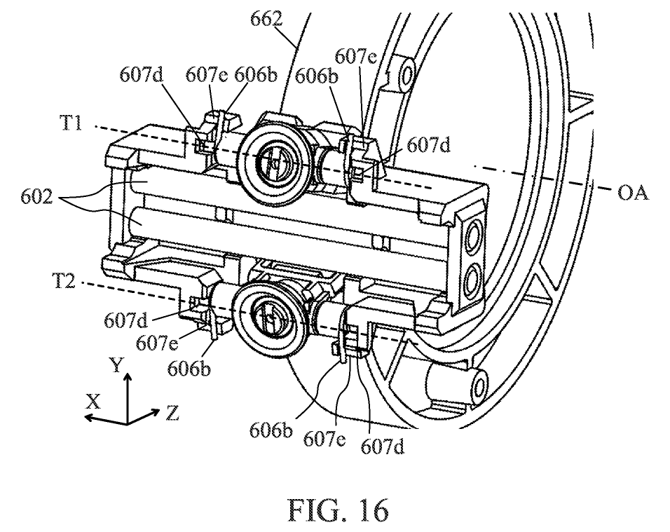

FIG. 16 illustrates an enlarged view of the lens holder 662 to which two movable guide bars 602 and two biasing units 605 are attached. The biasing unit 605, in which the torsion coil spring 606 is disposed as described above, has the protrusions 607b on both sides inserted into the engagement portions 607d of the lens holder 662. The arm portion 606b of the torsion coil spring 606 contacts the contact portion 607e of the lens holder 662. Due to this structure, a rotational force is applied to the biasing unit 605 using the protrusion 607b as the central axis (T1, T2 in FIG. 16).

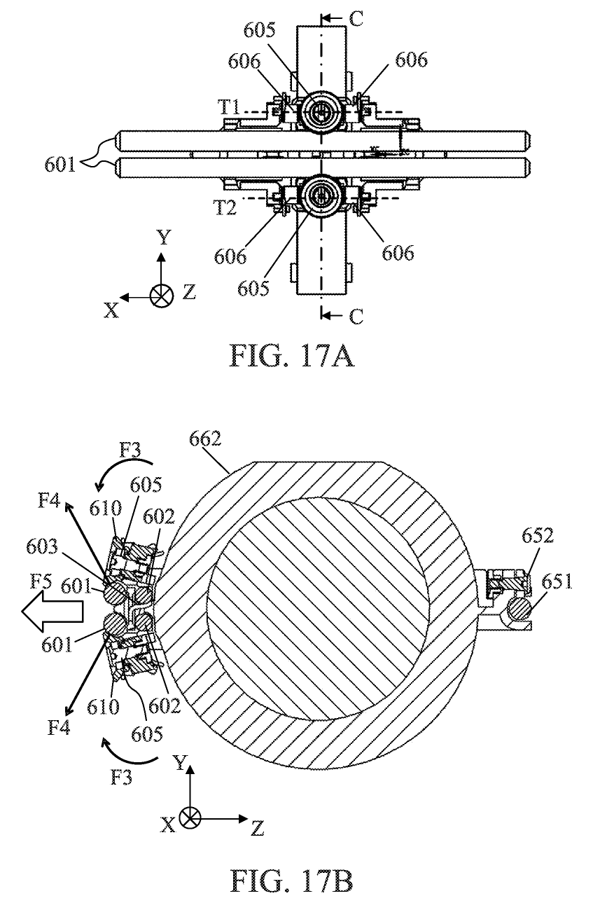

FIG. 17A illustrates the lens holder 662 when viewed from the main guide portion side, and FIG. 17B illustrates a C-C cross section in FIG. 17A.

The two biasing units 605 sandwich the two fixed guide bars 601 from both sides in the Y direction at positions corresponding to the centers of the two movable guide bars 602 in the optical axis direction. A rotational force (torque) F3 around T1 and T2 generated by the torsion coil springs 606 acts on the two biasing units 605, and causes the rollers 610 of the two biasing units 605 to press and contact the corresponding fixed guide bars 601. This pressive contact generates a reaction force F4 from the two fixed guide bars 601. As a result, a biasing force F5, which is the resultant force of the two reaction forces F4, acts from in the direction from the movable guide bar 602 to the fixed guide bar 601. Thereby, the two balls 603 are sandwiched and held between the two fixed guide bars 601 and the two movable guide bars 602. That is, the lens holder 662 is biased against the two fixed guide bars 601 via the two balls 603. Due to this structure, when the lens holder 662 moves in the optical axis direction along the two fixed guide bars 601, the two balls 603 roll between the two fixed guide bars 601 and the two movable guide bars 602. Thereby, the driving resistance of the lens holder 662 is extremely reduced.

The strength of the biasing force F5 can be adjusted by changing the spring force of the torsion coil spring 606.

The contact angle between the biasing unit 605 and the fixed guide bar 601 is determined by the diameter of the contact surface of the roller 610, and the diameter of the contact surface is set so that the biasing force F5 acts in the direction from the movable guide bar 602 to the fixed guide bar 601. The shape of the roller 610 is set so that, in addition to the above contact angle, the dimensions of the main guide unit 600 in the Z direction and the Y direction do not become too large.

The retainer 604 has the anti-dislodging portion described in the first embodiment. Thereby, the two balls 603 can be prevented from falling out from between the two movable guide bars 602 and the two fixed guide bars 601.

The rolling range of the two balls 603 is limited by the retainer 604, as in the first embodiment. The rolling range of the two balls 603 is set so that, for example, even when the retainer 604 contacts the +X-direction-side end of the lens holder 662, the two balls 603 are not positioned within the +X direction range of the center of the movable guide bar 602. Thereby, the center of gravity (line of action) of the biasing force F5 is always located between the two balls 603, and one of the balls 603 can be prevented from floating away from the respective guide bars.

In the first and second embodiments, the biasing force of the main guide is generated using the magnet. Magnetic biasing generates a leakage magnetic flux, which may negatively affect a sensor that uses magnetic force for position detection, for example. Therefore, consideration must be given to the installation position of the main guide. On the other hand, when the biasing force is generated mechanically, as in the third embodiment, the installation position of the main guide has a high degree of freedom. Furthermore, the biasing force can be easily changed, for example, due to a change in the mass of the lens, by simply changing the strength of the torsion coil spring 606.

In place of the two movable guide bars 602 in this embodiment, the V-grooved metal plate used in the second embodiment may be used. This embodiment places the fixed and movable guide bars of the main guide in the radial direction from the optical axis center. In order to improve space efficiency with surrounding units, they may not be arranged in radial directions from the optical axis center; for example, they may be arranged in directions perpendicular to the radial directions from the optical axis center.

In each embodiment described above, the main guide portion is configured to guide the lens holder in the optical axis direction and to bias the lens holder toward the fixed guide bar (to limit backlash or unsteadiness to one side). Each embodiment provides a biasing force generator on the lens holder or the movable guide bar or V-grooved metal plate fixed to it. Thus, a lens apparatus can have a simple structure, few design constraints, and a small drive load.

In each of the above embodiments, the main guide portion and sub-guide portion are diametrically opposite to each other with respect to the optical axis OA, but they may not be diametrically opposite to each other. For example, the sub-guide portion may be positioned circumferentially offset from the position that is diametrically opposite to the main guide portion with respect to the optical axis OA, as long as it suppresses the rotation of the lens holder around the ball. In each embodiment, the sub-guide portion is rollable using the ball or bearing, but may have a sliding structure relative to the sub-guide bar.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

For example, the optical apparatus according to each embodiment may include a biasing unit provided on the holding member, and the first guide member and the biasing unit may generate a biasing force that biases the holding member toward the first guide member. The biasing unit may generate the biasing force by biasing the first guide member in a direction different from a direction of the biasing force. The different direction may be an attraction direction (opposite to F1 or F2) of the fixed guide bar in the case of the magnet, or the direction F3 in the case of the biasing unit. A plurality of first guide members may be arranged in a direction perpendicular to the moving direction. The biasing force may bias the holding member against the first guide member via the rolling member.

Each embodiment can provide an optical apparatus with a simple structure and a small driving load on the optical element.

This application claims the benefit of Japanese Patent Application No. 2024-203571, which was filed on November 22, 2024, and which is hereby incorporated by reference herein in its entirety.

What is claimed is:

1. An optical apparatus comprising:
a base member;
a holding member that holds an optical element and is movable relative to the base member;
a first guide member fixed to the base member;
a second guide member fixed to the holding member;
a rolling member disposed between the first guide member and the second guide member; and
a biasing unit provided on the holding member,
wherein the rolling member rolls relative to the first guide member and the second guide member to guide a movement of the holding member, and
wherein the first guide member and the biasing unit generate a biasing force that biases the holding member toward the first guide member.

2. The optical apparatus according to claim 1, wherein the biasing unit generates the biasing force by biasing the first guide member in a direction different from a direction of the biasing force.

3. The optical apparatus according to claim 1, wherein the first guide member includes a plurality of guide portions arranged in a direction perpendicular to a moving direction of the holding member.

4. The optical apparatus according to claim 1, wherein the biasing force biases the holding member against the first guide member via the rolling member.

5. The optical apparatus according to claim 1, wherein the rolling member includes a plurality of rolling portions arranged in a moving direction of the holding member, and
wherein a center of gravity of the biasing force is located between the plurality of rolling portions.

6. The optical apparatus according to claim 5, wherein the biasing unit includes a plurality of biasing portions arranged in the moving direction so as to sandwich a center of the plurality of rolling portions in the moving direction.

7. The optical apparatus according to claim 5, wherein the biasing unit is disposed between the plurality of rolling portions in the moving direction.

8. The optical apparatus according to claim 5, wherein the optical apparatus further comprises a rolling holding member that rotatably holds the plurality of rolling portions so as not to approach each other in the moving direction.

9. The optical apparatus according to claim 1, wherein the first guide member is made of a magnetic material, and
wherein the biasing unit is a magnet that generates a magnetic attractive force as the biasing force between the biasing unit and the first guide member.

10. The optical apparatus according to claim 9, wherein the second guide member is made of a magnetic material and functions as a yoke for the magnet.

11. The optical apparatus according to claim 1, wherein the biasing unit presses the first guide member, thereby generating a reaction force as the biasing force on the first guide member.

12. The optical apparatus according to claim 1, further comprising a third guide member fixed to the base member and configured to prevent the holding member from rotating in a plane perpendicular to a moving direction of the holding member.

13. The optical apparatus according to claim 1, wherein the optical apparatus is attachable to and detachable from an image pickup apparatus.

14. An image pickup apparatus comprising:
the optical apparatus according to claim 1; and
an image sensor configured to capture an object image through the optical element.
